(19) United States
(12) Patent Application Publication
(10) Pub. No.: US 2012/0220503 A1
(43) Pub. Date: Aug. 30, 2012

(54) COMPOSITION AND METHOD FOR TREATING WELL BORE IN A SUBTERRANEAN FORMATION WITH CROSSLINKERS POLYMER FLUIDS

(76) Inventors: Javier Sanchez Reyes, Katy, TX (US); Michael D. Parris, Richmond, TX (US)

(21) Appl. No.: 13/033,643

(22) Filed: Feb. 24, 2011

(51) Int. Cl. C09K 8/62

(52) U.S. Cl. 507/213; 507/266; 507/211; 507/216; 507/215

(57) ABSTRACT

The concentrate solution for the crosslinking of polymers comprises water, polyol, a viscosifying agent, a first borate ion in solution, and a crosslinking agent able to release a second borate ion, wherein the second borate ion is not in solution.

### FIELD OF THE INVENTION

The invention relates to composition for treatment in a well bore within a subterranean formation. More particularly, some embodiments relate to compositions and methods of using an aqueous based borate crosslinker solution suspended in polyol and viscosifying agent.

### BACKGROUND

The statements in this section merely provide background information related to the present disclosure and may not constitute prior art.

In the art of recovering hydrocarbon values from subterranean formations, it is common, particularly in formations of low permeability, to hydraulically fracture the hydrocarbon-bearing formation to provide flow channels to facilitate production of the hydrocarbons to the wellbore. Fracturing fluids typically comprise a water or oil base fluid incorporating a polymeric thickening agent. The polymeric thickening agent helps to control leak-off of the fracturing fluid into the formation, aids in the transfer of hydraulic fracturing pressure to the rock surfaces and, primarily, permits the suspension of particulate proppant materials which remain in place within the fracture when fracturing pressure is released.

Typical polymeric thickening agents for use in fracturing fluids are polysaccharides polymers. For example, fracturing fluids comprise galactomannan gums such as guar and substituted guars such as hydroxypropyl guar or carboxymethylhydroxypropyl guar. Cellulosic polymers such as hydroxyethyl cellulose may also be used as well as synthetic polymers such as polyacrylamide. To increase the viscosity and, thus, the proppant carrying capacity as well as to increase the high temperature stability of the fracturing fluid, crosslinking of the polymers is also commonly practiced. Typical crosslinking agents comprise soluble boron, zirconium or titanium compounds. These metal ions provide for crosslinking or tying together of the polymer chains to increase the viscosity and improve the rheology of the fracturing fluid.

Of necessity, fracturing fluids are prepared on the surface and then pumped through tubing in the wellbore to the hydrocarbon-bearing subterranean formation. While high viscosity is a desirable characteristic of a fluid within the formation in order to efficiently transfer fracturing pressures to the rock as well as to reduce fluid leak-off, large amounts of hydraulic horsepower are required to pump such high viscosity fluids through the well tubing to the formation. In order to reduce the friction pressure, various methods of delaying the crosslinking of the polymers in a fracturing fluid have been developed. This allows the pumping of a relatively less viscous fracturing fluid having relatively low friction pressures within the well tubing with crosslinking being effected at or near the subterranean formation so that the advantageous properties of the thickened crosslinked fluid are available at the rock face.

It is known to provide the polymer crosslinking agents in the form of a concentrate suspended in an appropriate liquid suspension medium. Thus crosslinking agents have been suspended in aqueous liquids and non-aqueous liquids such as a hydrocarbon such as diesel, mineral oils, and kerosene, and alcohols containing 6-12 carbon atoms, vegetable oils, ester-alcohols, polyol ethers, glycols, animal oils, silicone oils, halogenated solvents, mineral spirits-resin solutions, and oil-resin solutions.

Numerous problems exist when utilizing these concentrates. Thus many of the non-aqueous liquid suspension mediums are environmentally unacceptable and have poor suspension and stability characteristics, and many are expensive and difficult to pump due to high viscosity or high abrasiveness on the pump. Aqueous based concentrates are unacceptable at low temperatures as their viscosity increases such that they become non-pourable or solidify.

### SUMMARY

In a first aspect, the concentrate solution for the crosslinking of polymers comprises water, polyol, a viscosifying agent, a first borate ion in solution, and a crosslinking agent able to release a second borate ion, wherein the second borate ion is not in solution.

In a second aspect, the concentrate solution for the crosslinking of polymers comprises water, polyol, a polymer viscosifying agent, a crosslinking agent able to release a borate ion and a calcium ion, and a chelating agent able to complex with said calcium ion.

In a third aspect, a method comprises providing a hydratable polymer; hydrating the hydratable polymer with an aqueous liquid; and crosslinking the hydratable polymer with a crosslinking concentrate solution comprising water, polyol, a viscosifying agent, a first borate ion in solution, and a crosslinking agent able to release a second borate ion, wherein the second borate ion is not in solution.

In a fourth aspect, a method comprises providing a hydratable polymer; hydrating the hydratable polymer with an aqueous liquid; and crosslinking the hydratable polymer with a crosslinking concentrate solution comprising water, a polyol, a polymer viscosifying agent, a crosslinking agent able to release a borate ion and a calcium ion, and a chelating agent able to complex with said calcium ion.

In a fifth aspect, a method of treating a subterranean formation adjacent a wellbore comprises providing a hydratable polymer; hydrating the hydratable polymer with an aqueous liquid to obtain a treatment fluid; adding to the treatment fluid a crosslinking concentrate solution comprising water, polyol, a viscosifying agent, a first borate ion in solution, and a crosslinking agent able to release a second borate ion, wherein the second borate ion is not in solution; and pumping the treatment fluid into the wellbore.

In a sixth aspect, a method of treating a subterranean formation adjacent a wellbore comprises providing a hydratable polymer; hydrating the hydratable polymer with an aqueous liquid to obtain a treatment fluid; adding to the treatment fluid a crosslinking concentrate solution comprising water, a polyol, a polymer viscosifying agent, a crosslinking agent able to release a borate ion and a calcium ion, and a chelating agent able to complex with said calcium ion; and pumping the treatment fluid into the wellbore.

### BRIEF DESCRIPTION OF DRAWINGS

FIG. 1 shows release of ions for a typical crosslinker solution and effect on fracturing fluid viscosity.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

According to an embodiment, an improved aqueous crosslinking concentrate solution for use in well treating fluids such as fracturing fluids, gravel packing fluids and the like is disclosed. The concentrate solution comprises water, polyol, a viscosifying agent, a first borate ion in solution, and a crosslinking agent able to release a second borate ion, wherein the second borate ion is not in solution and is still trapped in the crosslinking agent. In one embodiment, the crosslinking agent is suspended in the water mixture with the polyol and the viscosifying agent. The solution comprises borate ions in solution and further borate ions trapped in the crosslinking agent for slow release in the solution. Said slow released borate ions will be used for the crosslinking of polymers. In one embodiment, the amount of borate ions trapped in the crosslinking agent is of more than 90% wt, of more than 80% wt or of more than 70% wt of the total amount of borate ions releasable by the crosslinking agent.

The water mixture may be for example, water, aqueous based foams or water-alcohol mixture. Other aqueous liquids can be utilized so long as they do not adversely react with or otherwise affect other components of the crosslinking concentrate solution or the treating fluid formed therewith. The water may be fresh water, produced water, or seawater. The water may also be brine.

The crosslinking agent used to form the aqueous crosslinking concentrate solution include, but are not limited to, water soluble borate ion releasing compounds. Examples of such crosslinking agents include borate ion releasing compounds such as boric acid, boric oxide, pyroboric acid, metaboric acid, borax, sodium tetraborate, ulexite, colemanite, probertite, nobleite, gowerite, frolovite, meyerhofferite, inyoite, priceite, tertschite, ginorite, hydroboracite, inderborite, or mixtures thereof. The crosslinking agent can further comprise polyvalent metal cation releasing compounds capable of releasing cations such as magnesium, aluminum, titanium, zirconium, chromium, and antimony, and compositions containing these compounds. Examples of transition metal ion releasing compounds are titanium dioxide, zirconium oxychloride, zirconium acetylacetonate, titanium citrate, titanium malate, titanium tartrate, zirconium lactate, aluminum acetate, and other aluminum, titanium, zirconium, chromium, and antimony chelates.

In one embodiment, when the borate ion releasing compound is a mineral, for example as ulexite, colemanite, probertite, nobleite, gowerite, frolovite, meyerhofferite, inyoite, priceite, tertschite, ginorite, hydroboracite, inderborite, or mixtures thereof, the mineral is grained to fine or very fine powder: to an average from 4 microns to 100 microns. With such fine particles, abrasiveness of the pumps is reduced.

In one embodiment the crosslinking agent is a mixture of boric acid, borax and ulexite. In this case, the amount of borate ions trapped in the ulexite is of more than 90% wt, of more than 80% wt or of more than 70% wt of the total amount of borate ions releasable by the ulexite.

In one embodiment, the crosslinking agent can be a dual crosslinker agent comprising water soluble borate ion releasing compounds and zirconium IV ions releasing compounds. In some embodiments, a zirconium compound and a borate ion releasing compound are used. Borate ion releasing compounds which can be employed include, for example, any boron compound which will supply borate ions in the composition, for example, boric acid, alkali metal borates such as sodium diborate, potassium tetraborate, sodium tetraborate (borax), pentaborates and the like and alkaline and zinc metal borates. Such borate ion releasing compounds are disclosed in U.S. Pat. No. 3,058,909 and U.S. Pat. No. 3,974,077 herein incorporated by reference. In addition, such borate ion releasing compounds include boric oxide (such as selected from H₃BO₃ and B₂O₃) and polymeric borate compounds. Mixtures of any of the referenced borate ion releasing compounds may further be employed. Such borate-releasers typically require a basic pH (e.g., 7.0 to 12) for crosslinking to occur.

Typically, the crosslinking agent is employed in the solution in a concentration by weight of from about 1% to about 60% or from about 3% to about 50%, or from about 5% to about 45%.

The aqueous crosslinking concentrate solution includes one or more polyol freezing point depressants. The polyol freezing point depressants may be glycols such as ethylene glycol, diethylene glycol, diproplyleneglycol, polyethylene glycol, propylene glycol and sugar alcohols such as glycerol, sorbitol and maltose or the like to prevent the concentrate from freezing in cold weather.

The polyols are defined in one non-limiting embodiment as polyols having at least one hydroxyl group on two adjacent carbon atoms. The adjacent carbon atoms may have more than one hydroxyl group, and the polyol may have more than two adjacent carbon atoms, each having at least one hydroxyl group. In another embodiment, the polyols are monosaccharides, which are glycerols (trihydric monosaccharides having three hydroxyl groups) and sugar alcohols (having more than three hydroxyl groups) and oligosaccharides. In another embodiment, the polyols are acids, acid salts, fatty acids (alkyl glycosides), and alcohol, alkyl and amine derivatives (glycosylamines) of monosaccharides and oligosaccharides. Specific examples of polyols falling within these definitions include, but are not necessarily limited to, mannitol (manna sugar, mannite), sorbitol (D-sorbite, hexahydric alcohol), xylitol, glycerol, glucose, (dextrose, grape sugar, corn sugar), fructose (fruit sugar, levulose), maltose, lactose, tagatose, psicose, galactose, xylose (wood sugar), allose (β-D-allopyranose), ribose, arabinose, rhamnose, mannose, altrose, ribopyranose, arabinopyranose, glucopyranose, gulopyranose, galatopyranose, psicopyranose, allofuranose, gulofuranose, galatofuranose, glucosamine, chondrosamine, galactosamine, ethyl-hexo glucoside, methyl-hexo glucoside, aldaric acid, sodium aldarate, glucaric acid, sodium glucarate, gluconic acid, sodium gluconate, glucoheptonic acid, sodium glucoheptonate, and mixtures thereof. In one non-limiting embodiment, the molecular weight of the simple polyols may range from about 65 to about 500, where an alternate embodiment for the molecular weight ranges from about 90 to about 350. Oligosaccharides may have molecular weights ranging from about 450 to about 5000 in one non-limiting embodiment, with most ranging from about 480 to about 1000 in another non-limiting embodiment.

The polyol is combined with the water in an amount between about 5% to about 60% by weight, or between about 10% to about 50% by weight, or between about 15% to about 45% by weight.

In one embodiment, when a borate crosslinker is used alone, polyol and especially glycol will increase the solubility of borate compound. Therefore the crosslinker will contain some borate ion directly in solution due to the partial solubility of the borate compound. Also, other borate ion will not be in solution and will be slowly released thereafter. Therefore; the crosslink delay time will vary depending on the ratio of minerals and the amount of polyol added to the solution.

The concentrate solution is improved by adding a viscosifying agent or thickener. In one embodiment, the viscosifying agent includes but is not limited to diutan gum, starches, welan gum, guar gum, xanthan gum, carboxymethylcellulose, alginate, methylcellulose, tragacanth gum and karaya gum.

According to some embodiments, the viscosifying agent may be a polysaccharide such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds.

According to some embodiments, the viscosifying agent may be a synthetic polymer such as polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

According to some embodiments, the viscosifying agent may be a cellulose derivative such as hydroxyethylcellulose (HEC) or hydroxypropylcellulose (HPC), carboxymethylhydroxyethylcellulose (CMHEC) and carboxymethylcellulose (CMC).

According to some embodiments, the viscosifying agent may be a biopolymer such as xanthan, diutan, and scleroglucan.

According to some embodiments, the viscosifying agent may be a viscoelastic surfactant (VES). The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactants of the family of betaine is used.

Exemplary cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R₁N⁺(R₂)(R₃)(R₄)X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

According to some embodiments, the viscosifying agent may be an associative polymer for which viscosity properties are enhanced by suitable surfactants and hydrophobically modified polymers. For example, it may be a charged polymer in the presence of a surfactant having a charge that is opposite to that of the charged polymer, the surfactant being capable of forming an ion-pair association with the polymer resulting in a hydrophobically modified polymer having a plurality of hydrophobic groups, as described in published application U.S. 20040209780A1, Harris et. al.

The viscosifying agent is combined with the water and polyol in an amount between about 0.001% to about 5% by weight, or between about 0.01% to about 4% by weight, or between about 0.1% to about 2.5% by weight.

The crosslinking agent is able to release other ions compound that may have some undesirable effect on the concentrate. Effectively, when borate crosslinking agent is used. Due to the partial solubility of borate minerals in the crosslinker, ions other than boron are also present in the concentrate solution mainly calcium and sodium.

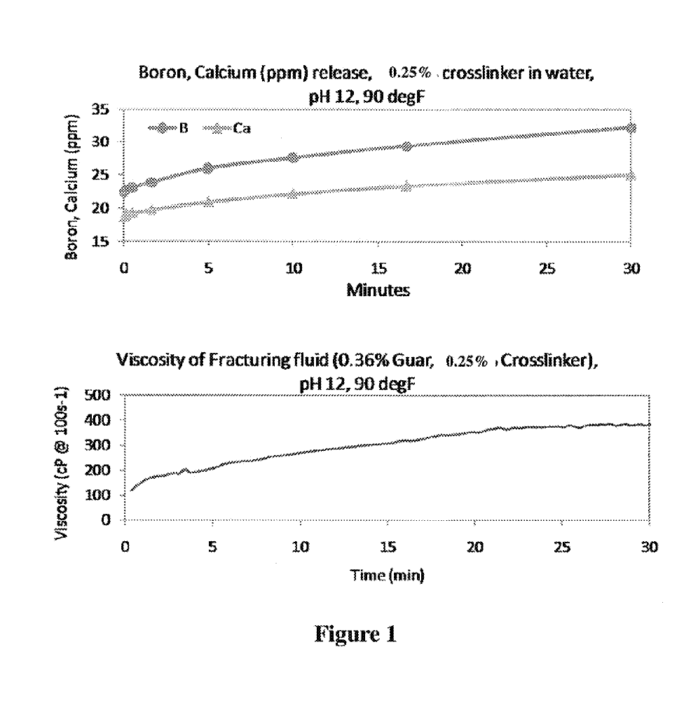

According to a further embodiment, the crosslinking agent is able to release calcium ion. Calcium in particular can interact with the viscosifying agent added to increase the crosslinker viscosity by forming a network. This undesirable effect can be reduced by adding a chelating agent able to complex with the calcium ion. FIG. 1 shows release of calcium and borate ions for a typical crosslinker solution.

The chelating agent may be a calcium complex agent such as sodium citrate, citric acid, malic acid, lactic acid, tartaric acid, phtalic acid, benzoic acid, ethylenediaminetetraacetic acid (EDTA), dimethylethylenediaminotetraacetic acid (DMEDTA), cyclohexyldiaminotetraacetic acid (CDTA) and mixtures thereof.

The chelating agent is present in the solution in an amount between about 0.001% to about 20% by weight, or between about 0.01% to about 15% by weight, or between about 0.5% to about 10% by weight.

Additionally, the crosslinker concentrate solution may contain a dispersant as an aid during the manufacturing process. The solution may additionally contain other materials (additives) well known in the art, such as additional additives, including, but not limited to, acids, fluid loss control additives, gas, corrosion inhibitors, scale inhibitors, catalysts, clay control agents, biocides, friction reducers, breakers, combinations thereof and the like.

According to a further embodiment, a method of preparing a well servicing fluid is disclosed. The method comprises hydrating a hydratable polymer, as for example a polysaccharide polymer (galactomannan gum or derivative thereof), in an aqueous liquid and thereafter crosslinking the polymer with the aqueous crosslinking concentrate solution as set forth above.

The well servicing fluid after being prepared can be used in various applications in a subterranean formation from a wellbore. The fluid may be a hydraulic fracturing fluid, a gravel pack fluid, but also a drilling fluid, a fluid loss fluid. The fluid may be not foamed, foamed, or energized, depending upon the particular formation properties and treatment objective.

Any suitable gas that forms a foam or an energized fluid when introduced into the aqueous medium can be used, see, for example, U.S. Pat. No. 3,937,283 (Blauer et al.) hereinafter incorporated by reference. The gas component may comprise a gas selected from the group consisting of nitrogen, air, carbon dioxide and any mixtures thereof. The gas component may comprise nitrogen, in any quality readily available. The gas component may in some cases assist in a fracturing operation and/or swell clean-up process. The fluid may contain from about 10% to about 90% volume gas component based upon total fluid volume percent, or from about 30% to about 80% volume gas component based upon total fluid volume percent, or from about 40% to about 70% volume gas component based upon total fluid volume percent.

In some embodiments, an acid buffer may be used to speed up the rate of hydration of polymer in brine. Embodiments may further contain other additives and chemicals. These include, but are not necessarily limited to, materials such as surfactants, breakers, breaker aids, oxygen scavengers, alkaline pH adjusting agents, clay stabilizers (i.e. KCl, TMAC), high temperature stabilizers, alcohols, proppant, scale inhibitors, corrosion inhibitors, fluid-loss additives, bactericides, and the like. Also, they may include a co-surfactant to optimize viscosity or to minimize the formation of stable emulsions that contain components of crude oil.

The hydratable polymer and the aqueous fluid are blended to form a hydrated solution. The hydratable polymer can be any of the hydratable polysaccharides having galactose or mannose monomer units and are familiar to those in the well service industry. These polysaccharides are used as viscosifying agents; they are capable of gelling in the presence of the crosslinking agent present in the solution to form a gelled base fluid.

According to some embodiments, the method disclosed herein can be used with a variety of polysaccharide used as viscosifying agents, including, but not limited to, guar gums, high-molecular weight polysaccharides composed of mannose and galactose sugars, or guar derivatives such as hydroxypropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used. Any useful polymer may be used in either crosslinked form, or without crosslinker in linear form. Xanthan, diutan, and scleroglucan, three biopolymers, have been shown to be useful as viscosifying agents. Polysaccharide compounds can be combined with other viscosifying agents, as viscoelastic surfactant. Nonlimiting examples of suitable viscoelastic surfactants useful for viscosifying some fluids include cationic surfactants, anionic surfactants, zwitterionic surfactants, amphoteric surfactants, nonionic surfactants, and combinations thereof. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion-pair association with the polymer resulting in a hydrophobically modified polymer having a plurality of hydrophobic groups, as described in published application U.S. 20040209780A1, Harris et. al.

In some embodiments, the viscosifier is a water-dispersible, nonionic, hydroxyalkyl galactomannan polymer or a substituted hydroxyalkyl galactomannan polymer. Examples of useful hydroxyalkyl galactomannan polymers include, but are not limited to, hydroxy-C₁-C₄-alkyl galactomannans, such as hydroxy-C₁-C₄-alkyl guars. Preferred examples of such hydroxyalkyl guars include hydroxyethyl guar (HE guar), hydroxypropyl guar (HP guar), and hydroxybutyl guar (HB guar), and mixed C₂-C₄, C₂/C₃, C₃/C₄, or C₂/C₄ hydroxyalkyl guars. Hydroxymethyl groups can also be present in any of these.

As used herein, substituted hydroxyalkyl galactomannan polymers are obtainable as substituted derivatives of the hydroxy-C₁-C₄-alkyl galactomannans, which include: 1) hydrophobically-modified hydroxyalkyl galactomannans, e.g., C₁-C₁₈-alkyl-substituted hydroxyalkyl galactomannans, e.g., wherein the amount of alkyl substituent groups is preferably about 2% by weight or less of the hydroxyalkyl galactomannan; and 2) poly(oxyalkylene)-grafted galactomannans (see, e.g., A. Bahamdan & W. H. Daly, in Proc. 8PthP Polymers for Adv. Technol. Int'l Symp. (Budapest, Hungary, September 2005) (PEG- and/or PPG-grafting is illustrated, although applied therein to carboxymethyl guar, rather than directly to a galactomannan)). Poly(oxyalkylene)-grafts thereof can comprise two or more than two oxyalkylene residues; and the oxyalkylene residues can be C₁-C₄ oxyalkylenes. Mixed-substitution polymers comprising alkyl substituent groups and poly(oxyalkylene) substituent groups on the hydroxyalkyl galactomannan are also useful herein. In various embodiments of substituted hydroxyalkyl galactomannans, the ratio of alkyl and/or poly(oxyalkylene) substituent groups to mannosyl backbone residues can be about 1:25 or less, i.e. with at least one substituent per hydroxyalkyl galactomannan molecule; the ratio can be: at least or about 1:2000, 1:500, 1:100, or 1:50; or up to or about 1:50, 1:40, 1:35, or 1:30. Combinations of galactomannan polymers according to the present disclosure can also be used.

As used herein, galactomannans comprise a polymannose backbone attached to galactose branches that are present at an average ratio of from 1:1 to 1:5 galactose branches:mannose residues. Galactomannans may comprise a 1→4-linked β-D-mannopyranose backbone that is 1→6-linked to α-D-galactopyranose branches. Galactose branches can comprise from 1 to about 5 galactosyl residues; in various embodiments, the average branch length can be from 1 to 2, or from 1 to about 1.5 residues. Branches may be monogalactosyl branches. In various embodiments, the ratio of galactose branches to backbone mannose residues can be, approximately, from 1:1 to 1:3, from 1:1.5 to 1:2.5, or from 1:1.5 to 1:2, on average. In various embodiments, the galactomannan can have a linear polymannose backbone. The galactomannan can be natural or synthetic. Natural galactomannans useful herein include plant and microbial (e.g., fungal) galactomannans, among which plant galactomannans are preferred. In various embodiments, legume seed galactomannans can be used, examples of which include, but are not limited to: tara gum (e.g., from Cesalpinia spinosa seeds) and guar gum (e.g., from Cyamopsis tetragonoloba seeds). In addition, although embodiments may be described or exemplified with reference to guar, such as by reference to hydroxy-C₁-C₄-alkyl guars, such descriptions apply equally to other galactomannans, as well.

When incorporated, the polysaccharide polymer based viscosifier may be present at any suitable concentration. In various embodiments hereof, the gelling agent can be present in an amount of from about 5 to about 60 pounds per thousand gallons of liquid phase, or from about 15 to about 40 pounds per thousand gallons, from about 15 to about 35 pounds per thousand gallons, 15 to about 25 pounds per thousand gallons, or even from about 17 to about 22 pounds per thousand gallons. Generally, the gelling agent can be present in an amount of from about 10 to less than about 50 pounds per thousand gallons of liquid phase, with a lower limit of polymer being no less than about 10, 11, 12, 13, 14, 15, 16, 17, 18, or 19 pounds per thousand gallons of the liquid phase, and the upper limited being less than about 50 pounds per thousand gallons, no greater than 59, 54, 49, 44, 39, 34, 30, 29, 28, 27, 26, 25, 24, 23, 22, 21, or 20 pounds per thousand gallons of the liquid phase. In some embodiments, the polymers can be present in an amount of about 20 pounds per thousand gallons. Hydroxypropyl guar, carboxymethyl hydroxypropyl guar, carboxymethyl guar, cationic functional guar, guar or mixtures thereof, are preferred polymers for use herein as a gelling agent. Fluids incorporating polymer based viscosifiers based viscosifiers may have any suitable viscosity, preferably a viscosity value of about 50 mPa-s or greater at a shear rate of about 100 s⁻¹ at treatment temperature, more preferably about 75 mPa-s or greater at a shear rate of about 100 s⁻¹, and even more preferably about 100 mPa-s or greater.

The amount of the crosslinking concentrate solution in the well treating fluid is from about 0.1 gallon to about 5 gallons per 1000 gallons of water in the well treating fluid.

The well treating fluids may additionally contain other materials (additives) such as additional additives, including, but not limited to, acids, fluid loss control additives, gas, corrosion inhibitors, scale inhibitors, catalysts, clay control agents, biocides, friction reducers, breakers, combinations thereof and the like. Generally the fluids contain a proppant such as high strength ceramics, sintered bauxite, and sand, all as is well known in the art.

In one aspect, the treatment method is used for hydraulically fracturing a subterranean formation. Techniques for hydraulically fracturing a subterranean formation will be known to persons of ordinary skill in the art, and will involve pumping the fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications”, Encyclopedia of Polymer Science and Engineering, vol. 10, pp. 328-366 (John Wiley & Sons, Inc. New York, N.Y., 1987) and references cited therein, the disclosures of which are incorporated herein by reference thereto.

In most cases, a hydraulic fracturing consists of pumping a proppant-free viscous fluid, or pad, usually water with some fluid additives to generate high viscosity, into a well faster than the fluid can escape into the formation so that the pressure rises and the rock breaks, creating artificial fractures and/or enlarging existing fractures. Then, proppant particles are added to the fluid to form a slurry that is pumped into the fracture to prevent it from closing when the pumping pressure is released. The proppant suspension and transport ability of the treatment base fluid traditionally depends on the type of viscosifying agent added.

In the fracturing treatment, fluids may be used in the pad treatment, the proppant stage, or both. The components of the fluid may be mixed on the surface. Alternatively, a portion of the fluid may be prepared on the surface and pumped down tubing while another portion could be pumped down the annular to mix down hole.

Another embodiment includes the fluid for cleanup. The term “cleanup” or “fracture cleanup” refers to the process of removing the fracture fluid (without the proppant) from the fracture and wellbore after the fracturing process has been completed. Techniques for promoting fracture cleanup traditionally involve reducing the viscosity of the fracture fluid as much as practical so that it will more readily flow back toward the wellbore.

The field preparation and pumping of the fracturing fluid can be performed by either of two processes: continuous mixing or batch mixing.

In the continuous process, water such as city water is drawn from a storage vessel at a known rate and the crosslinkable polymer is metered at a rate calculated to give the desired concentration of polymer in the water. The polymer will generally evenly disperse in the water and hydrate quickly. In the continuous process it is necessary to have fast hydration in order to quickly develop fluid viscosity for suspending the propping materials down the well and into the fracture and generate a fracture of sufficient width. Also, the polymer should be adequately hydrated before the crosslinking reaction occurs in order to maximize the viscosity of the crosslinked gel.

The other additives such as crosslinkers, surfactants, fluid loss additives, proppants, breakers, biocides, etc. are then added to the fluid. The resultant mixture is then pumped at a rate sufficient to initiate and propagate the fracture in the subterranean formation.

In the batch process, the desired amount of copolymer, which is available commercially as a powder or granular product or liquid emulsion, is dispersed in a tank (typically 20,000 gallon) filled with fresh water or city water and circulated for at least thirty minutes to dissolve or disperse the copolymer in the water.

With the copolymer dissolved or dispersed in the water, pumping operations are commenced. The crosslinker suspension and breaker are added to the water on the fly, so that crosslinking occurs between the surface and the formation. The crosslinked viscosity is developed at a subsurface location and is sufficient to generate the fracture of desired length and geometry.

Following breakdown of the formation in both the continuous and batch process, proppant is added to the fluid and carried to and deposited in the fracture. The well is then shut in permitting the fracture to close on the proppants and the breaker to degrade the crosslinked copolymer.

In another aspect, the fluid is useful for gravel packing a wellbore. As a gravel packing fluid, it may comprise gravel or sand and other optional additives such as filter cake clean up reagents such as chelating agents referred to above or acids (e.g. hydrochloric, hydrofluoric, formic, acetic, citric acid) corrosion inhibitors, scale inhibitors, biocides, leak-off control agents, among others. For this application, suitable gravel or sand is typically having a mesh size between 8 and 70 U.S. Standard Sieve Series mesh.

To facilitate a better understanding of the present invention, the following examples of embodiments are given. In no way should the following examples be read to limit, or define, the scope of the invention.

### EXAMPLES

A series of experiments were conducted to demonstrate improved properties of composition and method described herewith.

An aqueous suspension of soluble borates blends is made. The blend of two or more borates can consist of a combination of borax and boric acid and the minerals provided in Table 1. This blend provides a controllable crosslink times that can be tuned for different delayed target times. The amount of borate containing solids can range from 5% wt to 45% wt where the recommended formulation contains a combination of borax and ulexite.

TABLE 1

Probertite: NaCaB₅O₉•5H₂O
Ulexite: NaCaB₅O₉•8H₂O
Nobleite: CaB₆O₁₀•4H₂O
Gowerite: CaB₆O₁₀•SH₂O
Frolovite: Ca₂B₄O₈•7H₂O
Colemanite: Ca₂B₆O₁₁•5H₂O
Meyerhofferite: Ca₂B₆O₁₁•7H₂O
Inyoite: Ca₂B₆O₁₁•13H₂O
Priceite: Ca₄B₁₀O₁₉•7H₂O
Tertschite: Ca₄B₁₀O₁₉•20H₂O
Ginorite: Ca₂B₁₄O₂₃•8H₂O
Pinnoite: MgB₂O₄•3H₂O
Paternoite: MgB₈O₁₃•4H₂O
Kurnakovite: Mg₂B₆O₁₁•15H₂O
Inderite: Mg₂B₆O₁₁•15H₂O
Preobrazhenskite: Mg₃B₁₀O₁₈•4½H₂O
Hydroboracite: CaMgB₆O₁₁•6H₂O
lnderborite: CaMgB₆O₁₁•11H₂O
Kaliborite (Heintzite): KMg₂B₁₁O₁₉•9H₂O
Veatchite: SrB₆Oₗ₀•2H₂O

The borate blend is suspended in aqueous mixture of water and ethylene glycol. Glycols increase the solubility of some borate materials. For example, the solubility of borax decahydrate increases in from 5.8% in water to 41.6% in ethylene glycol at 25 degC. Table 2 shows the content of boron in solution for a blend of 4% borax and 39% ulexite. Therefore the crosslinker concentrate solution will contain some borate in solution due to the partial solubility of the borate materials and therefore; the crosslink delay time will vary depending on the ratio of minerals and the amount of ethylene glycol added to the suspension.

TABLE 2
Boron in solution for a borate blend
of 4% wt. Borax and 39% wt Ulexite.

| | Boron measured in | Calcium measured |
|---|---|---|
| Glycol Content | solution [ppm] | in solution [ppm] |
| 16% wt. Ethyleneglycol | 7,520 | 115 |
| 28% wt. Ethyleneglycol | 10,600 | 617 |
| 40% wt. Ethyleneglycol | 14,500 | 2,470 |

The crosslinker concentrate solution is improved by adding the viscosifying agent. Due to the partial solubility of borate minerals in the crosslinker, ions other than boron are also present in solution mainly calcium and sodium as illustrated in Tables 1 and 2. Calcium in particular can interact with the viscosifying agent to increase the crosslinker viscosity by forming a network. For example table 3 shows the viscosity increment in Diutan by the addition of calcium.

TABLE 3
Effect of viscosity on thickener
Viscosity of 0.36% wt Diutan in DI water, pH 7

| | No Calcium | 300 ppm Ca |
|---|---|---|
| Viscosity | 60,050 | 194,663 |
| [cp @ 0.017 s−1] | | |

This undesirable effect can be reduced by adding a calcium complex. Therefore, the crosslinker concentrate solution contains a calcium complex agent that can be sodium citrate, citric acid, malic acid, lactic acid, tartaric acid, phtalic acid, or the like. The formation constants for calcium chelating agents for some of chelating agents can be found in Table 4.

TABLE 4
Formation constants for calcium chelating agents

| | [Ca] log K |
|---|---|
| Ethylenediaminetetraacetic acid (EDTA) | 10.6 |
| Dimethylethylenediaminotetraacetic acid (DMEDTA) | 12.3 |
| Cyclohexyldiaminotetraacetic acid (CDTA) | 13.2 |
| Malic | 2.24 |
| Lactic | 1.55 |
| Citric | 2.64 |

Table 5 illustrates the effect of the chelating agents on the viscosity of ulexite solutions made of water with xanthan called S1. The amount of chelating agent varies from 0.1% wt to 10% wt. As it can be seen adding a chelating agent helps to maintain a viscosity of the concentrate crosslinker not influenced by calcium ions.

TABLE 5
Viscosity of ulexite solutions using
0.2% xanthan as suspending agent

| | | | Viscosity, |
|---|---|---|---|
| | | Cal- | cp @ |
| | | cium, | shear rate |
| Liquid Solution | pH | ppm* | 0.017 s⁻¹ |
| S1 without Calcium | 8.30 | 0 | 7.36E+03 |
| S1 with Ulexite | 8.33 | 1,080 | 3.84E+04 |
| S1 with Ulexite and 0.29% Citric Acid | 8.19 | 1,150 | 7.91E+03 |
| S1 with Ulexite and 0.41% Lactic Acid | 8.14 | 1,030 | 8.77E+03 |
| S1 with Ulexite and 0.30% Malic Acid | 8.27 | 1,070 | 5.68E+03 |
| S1 with Ulexite and 0.37% Phtalic Acid | 8.13 | 1,090 | 8.36E+03 |
| S1 with Ulexite and 0.34% Tartaric Acid | 8.18 | 1,066 | 2.59E+03 |
| S1 with Ulexite and 0.86% EDTA | 8.42 | 1,050 | 2.85E+03 |

*Calcium concentration (ppm) was measured by induced coupled plasma

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

What is claimed is:

1. A concentrate solution for the crosslinking of polymers comprising water, polyol, a viscosifying agent, a first borate ion in solution, and a crosslinking agent able to release a second borate ion, wherein the second borate ion is not in solution.

2. The solution of claim 1, wherein said crosslinking agent is selected from the group consisting of boric acid, boric osyde, pyroboric acid, metaboric acid, borax, sodium tetraborate, ulexite, colemanite, probertite, nobleite, gowerite, frolovite, meyerhofferite, inyoite, priceite, tertschite, ginorite, hydroboracite, inderborite and mixtures thereof.

3. The solution of claim 2, wherein the crosslinking agent is a mixture of borax, boric acid and ulexite.

4. The solution of claim 1, wherein the polyol is selected from the group consisting of ethylene glycol, diethylene glycol, diproplyleneglycol, polyethylene glycol, propylene glycol, glycerol, maltose and mixtures thereof.

5. The solution of claim 1, wherein the viscosifying agent is a viscoelastic surfactant.

6. The solution of claim 1, wherein the viscosifying agent is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethylcellulose (CMC), xanthan, diutan, scleroglucan and mixtures thereof.

7. The solution of claim 1, wherein the crosslinking agent is further able to release a calcium ion and the concentrate further comprising a chelating agent able to complex with said calcium ion.

8. The solution of claim 7, wherein the chelating agent is selected from the group consisting of: sodium citrate, citric acid, malic acid, lactic acid, tartaric acid, phtalic acid, benzoic acid, EDTA, DMEDTA, CDTA and mixtures thereof.

9. The solution of claim 7, wherein the chelating agent is present between 0.001% to about 20% by weight, or between about 0.01% to about 15% by weight, or between about 0.5% to about 10% by weight.

10. The solution of claim 1, wherein the first borate ion is released by the crosslinking agent when in solution.

11. A concentrate solution for the crosslinking of polymers comprising water, polyol, a polymer viscosifying agent, a crosslinking agent able to release a borate ion and a calcium ion, and a chelating agent able to complex with said calcium ion.

12. The solution of claim 11, wherein the crosslinking agent further comprises zirconium IV releasing compounds, polyvalent metal cation releasing compounds and mixtures thereof.

13. The solution of claim 11 wherein said crosslinking agent is selected from the group consisting of boric acid, boric osyde, pyroboric acid, metaboric acid, borax, sodium tetraborate, ulexite, colemanite, probertite, nobleite, gowerite, frolovite, meyerhofferite, inyoite, priceite, tertschite, ginorite, hydroboracite, inderborite and mixtures thereof.

14. The solution of claim 13, wherein the crosslinking agent is a mixture of borax, boric acid and ulexite.

15. The solution of claim 11, wherein the polyol is selected from the group consisting of ethylene glycol, diethylene glycol, diproplyleneglycol, polyethylene glycol, propylene glycol, glycerol, maltose and mixtures thereof.

16. The solution of claim 11, wherein the polymer viscosifying agent is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethylcellulose (CMC), xanthan, diutan, scleroglucan and mixtures thereof.

17. The solution of claim 11, wherein the chelating agent is selected from the group consisting of: sodium citrate, citric acid, malic acid, lactic acid, tartaric acid, phtalic acid, benzoic acid, EDTA, DMEDTA, CDTA and mixtures thereof.

18. The solution of claim 11, wherein the chelating agent is present between 0.001% to about 20% by weight, or between about 0.01% to about 15% by weight, or between about 0.5% to about 10% by weight.

19. A method comprising:
(a) providing a hydratable polymer;
(b) hydrating the hydratable polymer with an aqueous liquid; and
(c) crosslinking the hydratable polymer with a crosslinking concentrate solution comprising water, polyol, a viscosifying agent, a first borate ion in solution, and a crosslinking agent able to release a second borate ion, wherein the second borate ion is not in solution.

20. The method of claim 19, wherein the step of hydrating the hydratable polymer is done in a continuous process or batch process.

21. The method of claim 19 applying to a wellbore of a subterranean formation.

22. The method of claim 19, wherein said crosslinking agent is selected from the group consisting of boric acid, boric osyde, pyroboric acid, metaboric acid, borax, sodium tetraborate, ulexite, colemanite, probertite, nobleite, gowerite, frolovite, meyerhofferite, inyoite, priceite, tertschite, ginorite, hydroboracite, inderborite and mixtures thereof.

23. The method of claim 22, wherein the crosslinking agent is a mixture of borax, boric acid and ulexite.

24. The method of claim 19, wherein the polyol is selected from the group consisting of ethylene glycol, diethylene glycol, diproplyleneglycol, polyethylene glycol, propylene glycol, glycerol, maltose and mixtures thereof.

25. The method of claim 19, wherein the viscosifying agent is a viscoelastic surfactant.

26. The method of claim 19, wherein the viscosifying agent is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethylcellulose (CMC), xanthan, diutan, scleroglucan and mixtures thereof.

27. The method of claim 19, wherein the crosslinking agent is further able to release a calcium ion and the concentrate further comprising a chelating agent able to complex with said calcium ion.

28. The method of claim 27, wherein the chelating agent is selected from the group consisting of: sodium citrate, citric acid, malic acid, lactic acid, tartaric acid, phtalic acid, benzoic acid, EDTA, DMEDTA, CDTA and mixtures thereof.

29. The method of claim 27, wherein the chelating agent is present between 0.001% to about 20% by weight, or between about 0.01% to about 15% by weight, or between about 0.5% to about 10% by weight.

30. The method of claim 19, wherein the first borate ion is released by the crosslinking agent when in solution.

31. The method of claim 19, wherein the hydratable polymer is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethylcellulose (CMC), xanthan, diutan, scleroglucan, and mixtures thereof.

32. A method comprising:
(d) providing a hydratable polymer;
(e) hydrating the hydratable polymer with an aqueous liquid; and
(f) crosslinking the hydratable polymer with a crosslinking concentrate solution comprising water, a polyol, a polymer viscosifying agent, a crosslinking agent able to release a borate ion and a calcium ion, and a chelating agent able to complex with said calcium ion.

33. The method of claim 32, wherein the step of hydrating the hydratable polymer is done in a continuous process or batch process.

34. The method of claim 32 applying to a wellbore of a subterranean formation.

35. The method of claim 32, wherein the crosslinking agent further comprises zirconium IV releasing compounds, polyvalent metal cation releasing compounds and mixtures thereof.

36. The method of claim 32 wherein said crosslinking agent is selected from the group consisting of boric acid, boric osyde, pyroboric acid, metaboric acid, borax, sodium tetraborate, ulexite, colemanite, probertite, nobleite, gowerite, frolovite, meyerhofferite, inyoite, priceite, tertschite, ginorite, hydroboracite, inderborite and mixtures thereof.

37. The method of claim 32, wherein the polyol is selected from the group consisting of ethylene glycol, diethylene glycol, diproplyleneglycol, polyethylene glycol, propylene glycol, glycerol, maltose and mixtures thereof.

38. The method of claim 32, the polymer viscosifying agent is substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethylcellulose (CMC), xanthan, diutan, scleroglucan, and mixtures thereof.

39. The method of claim 32, wherein the chelating agent is selected from the group consisting of: sodium citrate, citric acid, malic acid, lactic acid, tartaric acid, phtalic acid, benzoic acid, EDTA, DMEDTA, CDTA and mixtures thereof.

40. The method of claim 32, wherein the chelating agent is present between 0.001% to about 20% by weight, or between about 0.01% to about 15% by weight, or between about 0.5% to about 10% by weight.

41. The method of claim 32, wherein the hydratable polymer is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethylcellulose (CMC), xanthan, diutan, scleroglucan, and mixtures thereof.
